(19) United States
(12) Patent Application Publication
(10) Pub. No.: US 2024/0230954 A9
(43) Pub. Date: Jul. 11, 2024

(54) CONTACT LENSES TO SEE UNDERWATER

(71) Applicant: Sung Huang, Irvine, CA (US)

(72) Inventor: Sung Huang, Irvine, CA (US)

(21) Appl. No.: 18/048,143

(22) Filed: Oct. 20, 2022

(51) Int. Cl. G02B 1/04

(52) U.S. Cl. CPC G02B 1/043

(57) ABSTRACT

An eye view system comprises a contact lens that has been built in with a layer of hydrogel glass on the outer surface of the lens with a slight air gap between creating a pocket of air between the wearer's eye and the surrounding water, which allows light to refract properly and help us to see clearly under water.

### FIELD OF THE INVENTION

The present invention relates to a contact lens, and particularly to a contact lens build in with a layer of air which allows light to refract properly and help us to see clearly under water.

### BACKGROUND OF THE INVENTION

It is very difficult for us to see underwater,

The human eye is designed to focus light onto the retina, but when you are underwater, the light is refracted and the image is not formed on the retina but somewhere behind it making things look differently,
Refraction of the light normally takes place when the light rays travel from the thinner air into the denser cornea. However, water has a similar density to the cornea, so light doesn't refract properly That's why when we're underwater, everything looks distorted or blurry.

Normally, light passes through the cornea, which begins focusing the light. It is then focused on the lens and onto the retinas, The images are then transmitted up the optic nerve to the visual center of the brain.

To see underwater, today divers wear flat diving masks to see underwater which uncomfortably tied up on the forehead, our vision is blurry and foggy when moisture builds up inside the mask.

### SUMMARY OF THE INVENTION

The present invention—Have a layer of hydrogel glass built in on the front of the contact lenses keeping a slight air gap between the lens's curved surface, creating a pocket of air between the wearer's eye and the surrounding water, which allows light to refract properly and help us to see clearly under water.

### BRIEF DESCRIPTION OF THE DRAWINGS

FIG. 1 shows one embodiment of the present invention. Including the contact lens 1 has a flat face hydrogel glass 3 built in the front with a slight air gap 2 between the lens's curve surface 4.

FIG. 1 shows the side view of the present invention and FIG. 2 shows the top view.

FIG. 3 shows the side view of another one embodiment of the present invention. Including the contact lens 1 has a round shaped hydrogel glass 5 built in on the front with a slight air gap 2.

FIG. 4 shows the present invention worn on the human eye by suction to eye tears fluids 6 onto eye cornea 7.

FIG. 5 shows using a larger present contact lens 8 placed under eyelid 9 to allow better protection for the lens not to slip away.

FIG. 6 shows an illustration of us human beings using flat glass mask goggles to see underwater.

FIG. 7 shows the illustration of how the human eye focuses.

FIG. 8 shows the illustration of today people wearing regular contact lenses with suction to eye tears fluids to eye cornea.

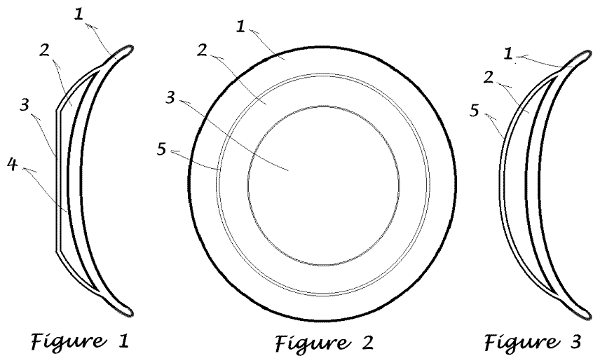

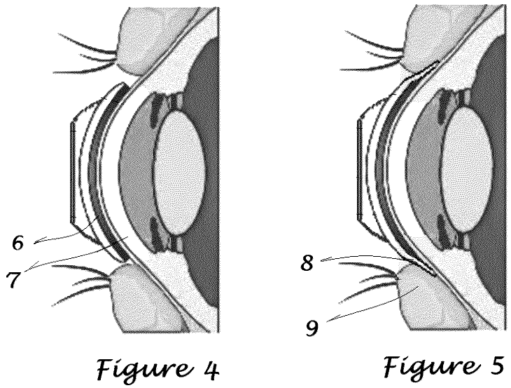

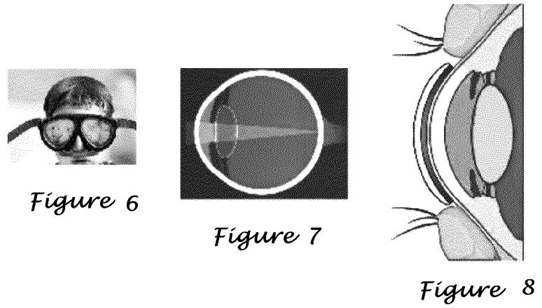

### DETAIL DESCRIPTION OF THE INVENTION

The preferred embodiments of the described invention relate particularly to an apparatus of a contact lens has been built with a layer of hydrogel glass in the front with a slight air gap between allowing a pocket of air to be formed between the wearer's eye and the surrounding water which, in turn, allows light to refract properly and help us to see clearly under water.

What is claimed is:

1. An eye view system to see underwater comprises: a contact lens that has a layer of hydrogel glass built in on the front of the contact lens with a slight air gap between the lens's curved surface creating a pocket of air between the wearer's eye and the surrounding water, which allows light to refract properly and help us to see clearly under water.

2. The eye view system of claim 1, where on the said contact lens's outer surface has been built a layer of hydrogel glass with a slight air gap between. The said contact lens is also made of same hydrogel glass.

3. The eye view system of claim 2, where on the outer surface of the contact lens has a slight air gap between the newly built flat face layer, which allows light to refract properly, and help us to see clearly underwater.

4. The eye view system of claim 3, where on the outer surface of the contact lens has a slight air gap between the newly built layer of hydrogel glass also could be in a round bowl shape, which allows more air space and better angle view underwater.

5. The eye view system of claim 2, where on the said contact lens made of hydrogel glass in bowl shape for wearer to suction to eye tears fluids to eye cornea will stay on underwater. A larger size contact lens to place under eyelid could offer better protection and help prevent slippage.
